(19) United States
(12) Patent Application Publication
(10) Pub. No.: US 2022/0271859 A1
(43) Pub. Date: Aug. 25, 2022

(54) WAVELENGTH SELECTIVE SWITCH WITH DIRECT GRATING INTERFACE

(71) Applicant: Nokia Solutions and Networks Oy, Espoo (FI)

(72) Inventors: Haoshuo Chen, Aberdeen, NJ (US); Nicolas Fontaine, New Providence, NJ (US); David Neilson, Old Bridge, NJ (US)

(21) Appl. No.: 17/180,455

(22) Filed: Feb. 19, 2021

(51) Int. Cl. H04J 14/02; H04Q 11/00; H04B 10/25

(52) U.S. Cl. CPC H04J 14/0212; H04Q 11/0005; H04B 10/25; H04Q 2011/0016

(57) ABSTRACT

Various example embodiments for a wavelength selective switch including a direct grating interface are presented. In at least some example embodiments, a wavelength selective switch may include a light propagating element having a tilted fiber grating integrated therein, thereby providing a direct grating interface to the light propagating element. It is noted that use of such a direct grating interface may obviate the need for use of various components typically utilized within wavelength selective switches (e.g., front-end optics in the port direction, front-end optics and diffractive gratings in the wavelength direction, and so forth), thereby enabling the size of wavelength selective switches to be reduced or even for the wavelength selective switches to be made compact or even ultra-compact.

### TECHNICAL FIELD

Various example embodiments relate generally to communication systems and, more particularly but not exclusively, to wavelength selective switches in communication systems.

### BACKGROUND

In various communication networks, various communications technologies may be used to support various types of communications.

### SUMMARY

In at least some example embodiments, an apparatus includes a light propagating element, a light steering element, and a light directing element. The light propagating element may be configured to propagate an optical signal. The light propagating element may include a tilted diffraction grating configured to extract the optical signal from the light propagating element or insert the optical signal onto the light propagating element. The light steering element may be configured to steer the optical signal for switching the optical signal from the light propagating element or switching the optical signal to the light propagating element. The light directing element may be configured to direct the optical signal between the light propagating element and the light steering element. In at least some example embodiments, the light propagating element may include at least one of an optical fiber, an optical waveguide, a three-dimensional optical waveguide, and a planar lightwave circuit. In at least some example embodiments, the tilted diffraction grating may include at least one of a titled fiber grating and a titled waveguide grating. In at least some example embodiments, the tilted diffraction grating may have a tilt angle of between approximately 30 degrees and approximately 60 degrees. In at least some example embodiments, the tilted diffraction grating may include a 45-degree tilted diffraction grating. In at least some example embodiments, the tilted diffraction grating may be inscribed within the light propagating element. In at least some example embodiments, the optical signal may include an optical beam including one or more wavelength channels, and the tilted diffraction grating may be configured to direct the optical beam. In at least some example embodiments, the optical signal may include an optical beam including a plurality of wavelength channels, and the tilted diffraction grating may be configured to spectrally separate the optical beam into the plurality of wavelength channels. In at least some example embodiments, the light directing element may include at least one lens. In at least some example embodiments, the at least one lens may include a first lens configured to direct the optical signal in a first direction and a second lens configured to direct the optical signal in a second direction. In at least some example embodiments, the at least one lens may include at least one spectrometer lens. In at least some example embodiments, the light directing element may be coupled to a portion of the light propagating element. In at least some example embodiments, the light steering element may include at least one of a liquid crystal on silicon (LCoS) element, a microelectromechanical (MEMS) elements, and a digital light processing (DLP) element. In at least some example embodiments, the optical signal may include a wavelength channel, and the light steering element may be configured to steer the wavelength channel between the light propagating element and a second light propagating element. In at least some example embodiments, the optical signal may include an optical beam including a set of N wavelength channels, and the light steering element may be configured to steer the optical beam between the light propagating element and a second light propagating element. In at least some example embodiments, the optical signal may include an optical beam comprising a set of N wavelength channels, and the light steering element may be configured to steer each of the N wavelength channels between the light propagating element and N additional light propagating elements. In at least some example embodiments, the apparatus may form part of a wavelength selective switch. In at least some example embodiments, the apparatus may be a wavelength selective switch. In at least some example embodiments, a method includes propagating, by a light propagating element including a tilted diffraction grating, an optical signal, wherein the tilted diffraction grating is configured to extract the optical signal from the light propagating element or insert the optical signal onto the light propagating element, steering the optical signal by a light steering element for switching the optical signal from the light propagating element or switching the optical signal to the light propagating element, and directing, by a light directing element, the optical signal between the light propagating element and the light steering element.

### BRIEF DESCRIPTION OF THE DRAWINGS

The teachings herein can be readily understood by considering the following detailed description in conjunction with the accompanying drawings, in which:

FIG. 1 depicts an example embodiment of a portion of a wavelength selective switch configured to support direct grating interfaces;

FIG. 2 depicts an example embodiment of a portion of a wavelength selective switch for illustrating a longitudinal cross-section of an optical fiber including a tilted fiber grating configured to support switching of optical signals;

FIG. 3 depicts an example embodiment of a portion of a wavelength selective switch for illustrating an array of optical fibers including tilted fiber gratings configured to support switching of optical signals;

FIGS. 4A-4E depict aspects of an experiment for a wavelength selective switch using tilted fiber gratings for interleaving optical signals for two ports with 500 GHz spacing and 200 GHz spacing;

FIG. 5 depicts an example embodiment of a wavelength selective switch with direct grating interfaces integrated within single-core multi-mode fibers;

FIG. 6 depicts an example embodiment of a wavelength selective switch with direct grating interfaces integrated within multi-core single-mode fibers;

FIG. 7 depicts an example embodiment of a method for use of a wavelength selective switch including a direct grating interface; and

FIG. 8 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

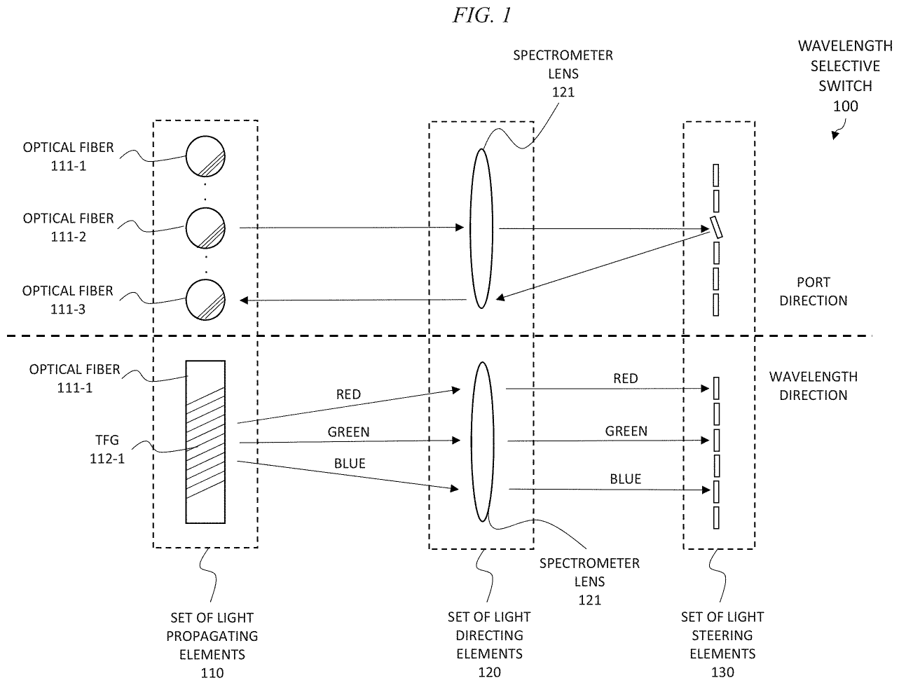

Various example embodiments for a wavelength selective switch including a direct grating interface are presented. In at least some example embodiments, a wavelength selective switch may include a light propagating element having a tilted diffraction grating integrated therein, thereby providing a diffractive light propagating element having a direct grating interface configured to support spectral separation, in free space, of wavelengths of an optical beam propagated on the light propagating element for supporting switching of the wavelengths of the optical beam. In at least some example embodiments, a wavelength selective switch may include a set of light propagating elements (e.g., optical waveguides such as optical fibers or three-dimensional (3D) waveguides, planar lightwave circuits, or other types of light propagating elements) having tilted diffraction gratings (e.g., tilted waveguide gratings, tilted fiber gratings such as 45-degree tilted fiber gratings, or other suitable types of tilted diffraction gratings) included therein to provide a set of diffractive light propagating elements, a set of light directing elements (e.g., one or more lenses, such as spectrometer lenses, or other suitable types of light directing elements), and a set of light steering elements (e.g., liquid crystal on silicon (LCoS) elements, microelectromechanical (MEMS) elements, digital light processing (DLP) elements, or other suitable types of light steering elements), where the set of light propagating elements is configured to propagate optical signals toward (ingress) and away from (egress) the wavelength selective switch, the set of light directing elements is configured to direct optical signals between the light propagating elements and the light steering elements, and the set of light steering elements is configured to support steering of optical signals in a manner for supporting switching of optical signals (e.g., individual wavelengths, optical beams composed of multiple wavelength channels, or the like). It is noted that use of such direct grating interfaces may obviate the need for use of various components which are typically utilized within wavelength selective switches (e.g., front-end optics in the port direction, front-end optics and diffractive gratings in the wavelength direction, and so forth), thereby enabling wavelength selective switch size to be reduced such that wavelength selective switches may be made compact or even ultra-compact. It will be appreciated that, although primarily presented herein with respect to use of the direct grating interface within a wavelength selective switch, the direct grating interface may be utilized within various other types of communication devices which may support optical communications. It will be appreciated that these as well as various other example embodiments, and associated advantages or potential advantages, may be further understood by considering the wavelength selective switch presented in FIG. 1.

FIG. 1 depicts an example embodiment of a wavelength selective switch configured to support direct grating interfaces.

The wavelength selective switch (WSS) 100 is configured to support optical communications. The WSS 100 may be configured to support optical communications in various contexts, such as for various types of communication networks (e.g., backbone communication networks, submarine transmission systems, fiber to the home (FTTH) networks, or the like), communications networks supporting various types of optical communications (e.g., individual wavelengths, wavelength division multiplexing (WDM) signals, dense WDM (DWDM) signals, or the like), communication networks supporting various types of traffic (e.g., voice, data, or the like), or the like, as well as various combinations thereof. For example, the

The WSS 100 includes a set of light propagating elements 110, a set of light directing elements 120, and a set of light steering elements 130. The set of light propagating elements 110, the set of light directing elements 120, and the set of light steering elements 130 may cooperate to support switching of optical signals at the WSS 100. The set of light propagating elements 110, the set of light directing elements 120, and the set of light steering elements 130 may cooperate to support wavelength selective switching of optical signals at the WSS 100. The set of light propagating elements 110, the set of light directing elements 120, and the set of light steering elements 130 may cooperate to support switching of optical signals in the port direction (e.g., switching of optical beams composed of wavelength channels) and switching of optical signals in the wavelength direction (e.g., switching of wavelength channels spectrally separated from optical beams), each of which is depicted for the WSS 100 of FIG. 1.

The set of light propagating elements 110 is configured to propagate optical signals toward the WSS 100 (e.g., ingress) and away from the WSS 100 (e.g., egress). The set of light propagating elements 110 includes three optical fibers 111-1-111-3 (collectively, optical fibers 111) having three tilted fiber gratings (TFGs) 112-1-112-3 (collectively, TFGs 112) associated therewith, respectively. The TFGs 112 are associated with the optical fibers 111 so as to provide direct grating interfaces for the optical fibers 111. It is noted that the optical fibers 111 including the TFGs 112 also may be referred to as diffractive optical fibers. It will be appreciated that the integration of the TFGs 112 within the optical fibers 111 may obviate the need for use of various components typically utilized within wavelength selective switches (e.g., front-end optics in the port direction, front-end optics and diffractive gratings in the wavelength direction, and so forth), thereby enabling the size of wavelength selective switches to be reduced or even for the wavelength selective switches to be made ultra-compact.

The optical fibers 111 may include any optical fibers suitable for supporting propagation of optical signals for the WSS 100. For example, the optical fibers 111 may include multi-mode fibers or single-mode fibers, single-core fibers or multi-core fibers, or the like, as well as various combinations thereof. The optical fibers 111 may be configured to propagate various types of optical signals, such as optical beams composed of wavelength channels (e.g., WDM signals, DWDM signals, or the like), individual wavelength channels extracted from optical beams (e.g., individual wavelength signals), or the like, as well as various combinations thereof. It will be appreciated that, although primarily presented with respect to use of three optical fibers 111, fewer or more optical fibers 111 having associated TFGs 112 may be utilized to support communications of the WSS 100.

The TFGs 112 are configured to provide direct grating interfaces for the optical fibers 111. The TFG 112 of an optical fiber 111 is configured to operate as an interface between the optical fiber 111 and other light control elements of the WSS 100, thereby enabling switching of optical signals (e.g., individual wavelength channels, optical beams composed of multiple wavelength channels, or the like, as well as various combinations thereof) at the WSS 100. The TFG 112 of an optical fiber 111, in the ingress direction, may be configured to direct optical signals propagating on the optical fiber 111 toward the set of light steering elements 130 via the set of light directing elements 120 for switching of the optical signals. The TFG 112 of an optical fiber 111, in the ingress direction for an optical beam including multiple wavelength channels, may be configured to spectrally separate the optical beam, in free space, into the wavelength channels and to direct the wavelength channels toward the set of light steering elements 130 via the set of light directing elements 120 for switching of the wavelength channels. The TFG 112 of an optical fiber 111, in the egress direction, may be configured to direct optical signals received from the set of light steering elements via the set of light directing elements 120 onto the optical fiber 111 for propagation via the optical fiber 111.

The TFGs 112 may be configured in various ways. The TFGs 112 may be written or inscribed within the optical fibers 111. The TFGs 112 may be 45-degree TFGs or may utilize tilting at various other angles. It will be appreciated that, as the angle of tilt of the TFGs 112 diverges from 45 degrees (e.g., toward 0 degrees or toward 90 degrees), the TFGs 112 may still support adequate coupling of light between the optical fibers 111 and the set of light directing elements 120, however, the efficiency with which the TFGs 112 couple the light between the optical fibers 111 and the set of light directing elements 120 may be less than the efficiency with which the TFGs 112 couple the light between the optical fibers 111 and the set of light directing elements 120 when the angle of tilt of the TFGs 112 is at or near 45 degrees (e.g., the efficiency may decrease with increased deviation of the angle of tilt of the TFGs 112 from 45 degrees). As such, it will be appreciated that, although primarily presented herein with respect to example embodiments in which the TFGs 112 are 45-degree TFGs, the TFGs 112 may have various other title angles. For example, the TFGs 112 may be configured to have a tilt angle between approximately 40 degrees and approximately 50 degrees. For example, the TFGs 112 may be configured to have a tilt angle between approximately 30 degrees and approximately 60 degrees. It will be appreciated that various other tilt angles may be used for the TFGs 112. It will be appreciated that the TFGs 112 may utilize various other tilt angles, that different ones of the TFGs 112 may use different tilt angles, or the like, as well as various combinations thereof. It will be appreciated that the TFGs 112 of the optical fibers 111 may be configured in various other ways.

It will be appreciated that, although primarily presented with respect to use of a specific type of light propagating element (namely, optical fibers 111) including a specific type of tilted diffraction grating (namely, TFGs 112), direct grating interfaces may be applied to other types of light propagating elements (e.g., 3D waveguides, planar lightwave circuits, or the like) for supporting reductions in the size of wavelength selective switches, other types of tilted diffraction gratings may be used (e.g., tilted waveguide gratings, other suitable types of tilted diffraction gratings, or the like) for supporting reductions in the size of wavelength selective switches, or the like, as well as various combination thereof.

The set of light directing elements 120 is configured to direct optical signals between the set of light propagating elements 110 and the set of light steering elements 130 (e.g., from the set of light propagating elements 110 toward the set of light steering elements 130 in the egress direction and from the set of light steering elements 130 toward the set of light propagating elements 110 in the egress direction). The set of light directing elements 120 includes a spectrometer lens 121. The spectrometer lens 121 may be a cylindrical spectrometer lens, a spherical spectrometer lens, or the like. It will be appreciated that, although primarily presented with respect to use of a single lens for the set of light directing elements 120 (namely, lens 121), the set of light directing elements 120 may include multiple lenses (e.g., one lens configured to direct optical signals propagating in the port direction and one lens configured to direct optical signals propagating in the wavelength direction, multiple lenses configured to direct optical signals propagating in the port direction and/or multiple lenses configured to direct optical signals propagating in the wavelength direction, or the like, as well as various combinations thereof). It will be appreciated that, although primarily presented with respect to use of a specific type of light directing element (namely, a spectrometer lens 121) in the set of light directing elements 120, various other types of light directing elements 120 also or alternatively may be used in the set of light directing elements 120.

The set of light steering elements 130 is configured to steer optical signals in a manner for supporting switching of the optical signals. The set of light steering elements 130 is configured to reflect optical signals from the optical fibers 111 (ingress direction) back toward the optical fibers 111 (egress direction). The optical signals that are switched based on the steering by the light steering elements 130 may be switched between optical fibers 111 (e.g., between multi-mode cores on different optical fibers 111, between single-mode cores on different optical fibers 111, or the like), between cores on the same optical fiber 111 (e.g., between single-mode cores on the same optical fiber 111, or the like), as well as various combinations thereof. The optical signals that are switched based on the steering by the light steering elements 130 may include one or more wavelengths (e.g., switching of individual wavelength channels, switching of optical beams including multiple wavelength channels, or the like, as well as various combinations thereof). The set of light steering elements 130 may include any suitable types of light steering components, such as LCoS elements (e.g., LCoS panels), MEMS elements (e.g., MEMS mirrors or mirror arrays), DLP elements (e.g., DLP panels), or the like.

In FIG. 1, as indicated above, two views of the directions of propagation are shown, including the port direction and the wavelength direction. The port direction illustrates the three optical fibers 111 being viewed in an end view or cross-sectional view (i.e., being viewed in a direction in which the reader is looking into the optical fibers 111 as if the optical fibers 111 are emerging from the paper toward the reader), such that all three optical fibers 111 are visible to the reader. The wavelength direction illustrates the three optical fibers 111 being viewed in a top view, such that only the top one of the three optical fibers 111 (namely, the optical fiber 111-1) is visible to the reader with a view of the other two optical fibers 111 (namely, optical fiber 111-2 and optical fiber 111-3) being obstructed by the top one of the three optical fibers 111. It is noted that the port direction view and the wavelength direction view both represent the same example embodiments.

In FIG. 1, in the port direction, the set of light propagating elements 110, the set of light directing elements 120, and the set of light steering elements 130 are configured to switch optical signals between the optical fibers 111. For example, an optical signal propagating on the optical fiber 111-2 is directed by the TFG 112-2 toward the spectrometer lens 121. In this example, the optical signal may be an individual wavelength channel or an optical beam composed on multiple wavelength channels. The spectrometer lens 121 directs the optical signal toward the set of light steering elements 130. The optical signal is incident on one of the light steering elements 130 which is actuated to steer the optical signal for further propagation on the optical fiber 111-3. The optical signal, after being steered by the light steering element 130 back toward the spectrometer lens 121, is directed by the spectrometer lens 121 to the optical fiber 111-3. The TFG 112-3 of the optical fiber 111-3 directs the optical signal onto the optical fiber 111-3 for propagation on the optical fiber 111-3. It will be appreciated that the WSS 100 may be configured to demultiplex an incoming optical signal received on one of the optical fibers 111 and send the resulting component optical signals over multiple optical fibers 111 (e.g., 1:N switching), multiplex multiple incoming optical signals received on multiple optical fibers 111 onto a common one of the optical fibers 111 (e.g., N:1 switching), switch various optical signals between various optical fibers 111 or portions of optical fibers 111 (e.g., N:M switching, such as where some or all of the optical signals received on one or more input ports are sent to one or more output ports), or the like, as well as various combinations thereof.

In FIG. 1, in the wavelength direction, the set of light propagating elements 110, the set of light directing elements 120, and the set of light steering elements 130 are configured to switch individual wavelengths between the optical fibers 111.

For example, an optical signal propagating on the optical fiber 111-1 is directed by the TFG 112-1 toward the spectrometer lens 121. In this example, the optical signal is an optical beam composed of wavelengths channels (denoted as red, green, and blue). The TFG 112-1 spectrally separates the optical beam into the three wavelengths channels and directs the three wavelength channels toward the spectrometer lens 121. The spectrometer lens 121 directs the three wavelength channels toward the set of light steering elements 130. The three wavelength channels are incident on ones of the light steering elements 130, respectively, which (although omitted for purposes of clarity) may be actuated to steer the three wavelength channels for further propagation on one or more of the optical fibers 111. The three wavelength channels, after being steered by the light steering elements 130 back toward the spectrometer lens 121, may be directed by the spectrometer lens 121 onto one or more of the optical fibers 111 by the TFGs 112 of the one or more optical fibers 111, respectively. It will be appreciated that the WSS 100 may be configured to support switching of various wavelength channels or combinations of wavelength channels between the optical fibers 111.

It will be appreciated that, although primarily presented with respect to use of common elements (e.g., spectrometer lens 121, the light steering elements 130, and so forth) for the port direction and the wavelength direction, in at least some example embodiments different elements may be used for the port direction and the wavelength direction (e.g., one or more spectrometer lenses for the port direction and one or more spectrometer lenses for the wavelength direction, one LCoS for the port direction and one LCoS for the wavelength direction, or the like, as well as various combinations thereof).

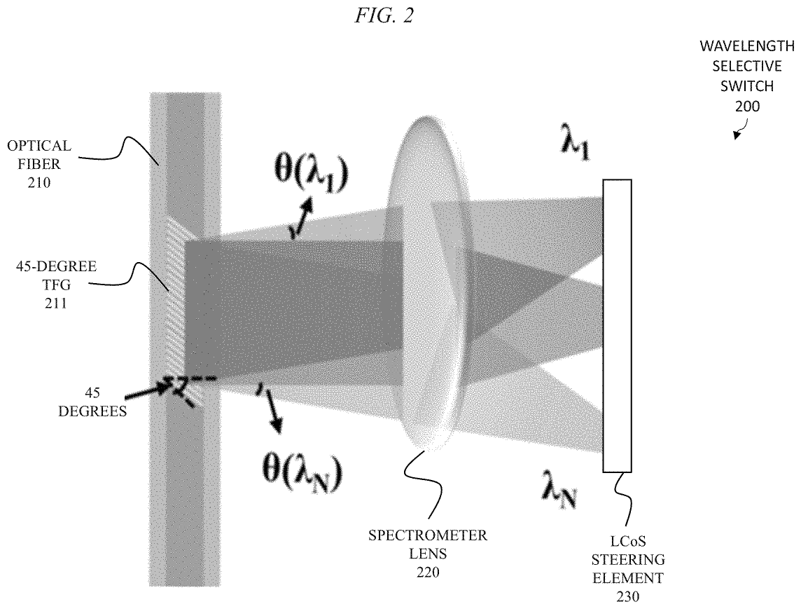

FIG. 2 depicts an example embodiment of a portion of a wavelength selective switch for illustrating a longitudinal cross-section of an optical fiber including a tilted fiber grating configured to support switching of optical signals.

The WSS 200 includes an optical fiber 210 having a 45-degree TFG 211 inscribed therein, a spectrometer lens 220, and an LCoS steering element 230. It is noted that the 45-degree angle of the 45-degree TFG 211 is marked for purposes of clarity. In FIG. 2, it is assumed that light is propagating along the optical fiber 210 in a direction from top to bottom on the page.

In the case in which the optical fiber 210 is an input fiber propagating an optical beam composed of a set of N wavelength channels (illustratively, denoted as λ₁ though λ_{N}), the 45-degree TFG 211 spectrally separates the N wavelength channels and directs the N wavelength channels toward the spectrometer lens 220, and the spectrometer lens 220 directs the N wavelength channels toward the LCoS steering element 230 for steering by the LCoS steering element 230 (e.g., to one or more output fibers which are omitted for purposes of clarity). From this example it may be seen that the WSS 200 supports 1:N switching of wavelength channels.

In the case in which the optical fiber 210 is an output fiber configured to propagate an optical beam composed of a set of N wavelength channels (illustratively, denoted as λ₁ though λ_{N}), the LCoS steering element 230 steers the N wavelengths channels (e.g., received from to one or more input fibers which are omitted for purposes of clarity) toward the spectrometer lens 220 which directs the N wavelength channels onto the 45-degree TFG 211, and the 45-degree TFG 211 spectrally combines the N wavelength channels onto the optical fiber 210 for propagation on the optical fiber 210. From this example it may be seen that the WSS 200 supports N:1 switching of wavelength channels.

In this manner, the WSS 200 is configured to support various types of wavelength selective switching while the overall size of the WSS 200 is reduced.

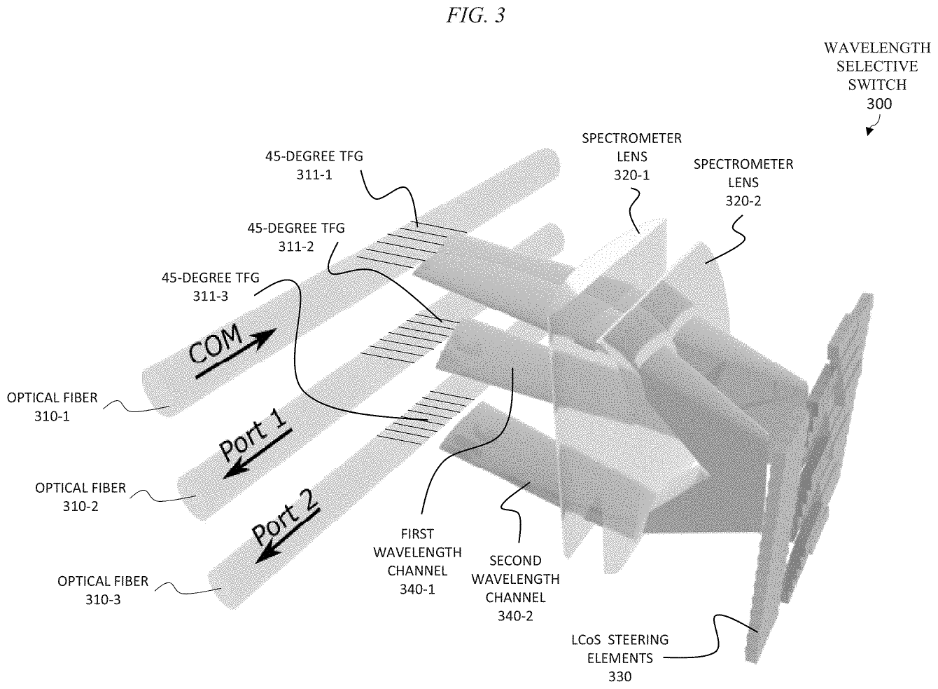

FIG. 3 depicts an example embodiment of a portion of a wavelength selective switch for illustrating an array of optical fibers including tilted fiber gratings configured to support switching of optical signals.

The WSS 300 includes three optical fibers 310-1-310-3 (collectively, optical fibers 310) having 45-degree TFGs 311-1-311-3 (collectively, 45-degree TFGs 311) inscribed therein, two spectrometer lenses 320-1 and 320-2 (collectively, lenses 320), and an LCoS steering element 330. The optical fiber 310-1 is associated with a common (COM) port and propagates light in one direction and the optical fibers 310-2 and 310-3 are associated with a Port 1 and a Port 2, respectively, and propagate light in the opposite direction. It will be appreciated that the propagation directions of the optical fibers 310 may change depending on whether the WSS 300 is performing 1:N switching (e.g., switching wavelength channels received via the COM port to Port 1 and Port 2) or N:1 switching (e.g., switching wavelength channels received via Port 1 and Port 2 onto the COM port).

The WSS 300, as indicated above, may be configured to perform 1:N switching (e.g., switching wavelength channels received via the COM port to Port 1 and Port 2). The spectrometer lens 320-1 is configured to pass light in the port direction and direct light in the wavelength direction toward the LCoS steering element 330 and the spectrometer lens 320-2 is configured to pass light in the wavelength direction and direct light in the port direction toward the LCoS steering element 330. The 45-degree TFG 311-1 directs a portion of the light propagating in the optical fiber 310-1 toward the spectrometer lenses 320 for steering by the LCoS steering element 330. The light that is directed by the 45-degree TFG 311-1 of the optical fiber 310-1 includes a first wavelength channel 340-1 and a second wavelength channel 340-2 (collectively, wavelength channels 340), which are indicated using different shading in FIG. 3. The light of both wavelength channels 340 passes through the spectrometer lens 320-1 and is redirected by the spectrometer lens 320-2 onto the LCoS steering element 330. The light of the first wavelength channel 340-1 is steered by the LCoS steering element 330 and reflected back toward the spectrometer lenses 320, is directed by the spectrometer lens 320-2 toward the optical fiber 310-2 associated with Port 1, passes through the spectrometer lens 320-1, and is redirected onto the optical fiber 310-2 associated with Port 1 by the 45-degree TFG 311-2 of the optical fiber 310-2 for further propagation of the first wavelength channel 340-1 along the optical fiber 310-2. The light of the second wavelength channel 340-2 is steered by the LCoS steering element 330 and reflected back toward the spectrometer lenses 320, is directed by the spectrometer lens 320-2 toward the optical fiber 310-3 associated with Port 2, passes through the spectrometer lens 320-1, and is redirected onto the optical fiber 310-3 associated with Port 2 by the 45-degree TFG 311-2 of the optical fiber 310-3 for further propagation of the second wavelength channel 340-2 along the optical fiber 310-3. In this manner, the WSS 300 is configured to support switching of multiple wavelengths from the optical fiber 310-1 associated with the COM port to the optical fibers 310-2 and 310-3 associated with Port 1 and Port 2, respectively, while the overall size of the WSS 300 is reduced.

The WSS 300, as indicated above, also may be configured to perform N:1 switching (e.g., switching wavelength channels received via Port 1 and Port 2 onto the COM port). It is noted that, while a detailed description of this mode of operation is omitted for purposes of brevity, the operation will proceed in a manner similar to, but opposite, that described above for performing 1:N switching. In N:1 switching, the first wavelength channel 340-1 received via the optical fiber 310-2 and the second wavelength channel 340-2 received via the optical fiber 310-3 may be directed to the 45-degree TFG 311-1 of the optical fiber 310-1, which directs the first wavelength channel 340-1 and the second wavelength channel 340-2 onto the optical fiber 310-1 to provide thereby an optical beam, including the first wavelength channel 340-1 and the second wavelength channel 340-2, for further propagation along the optical fiber 310-1. In this manner, the WSS 300 is configured to support switching of multiple wavelengths from the optical fibers 310-2 and 310-3 associated with Port 1 and Port 2, respectively, to the optical fiber 310-1 associated with the COM port, while the overall size of the WSS 300 is reduced.

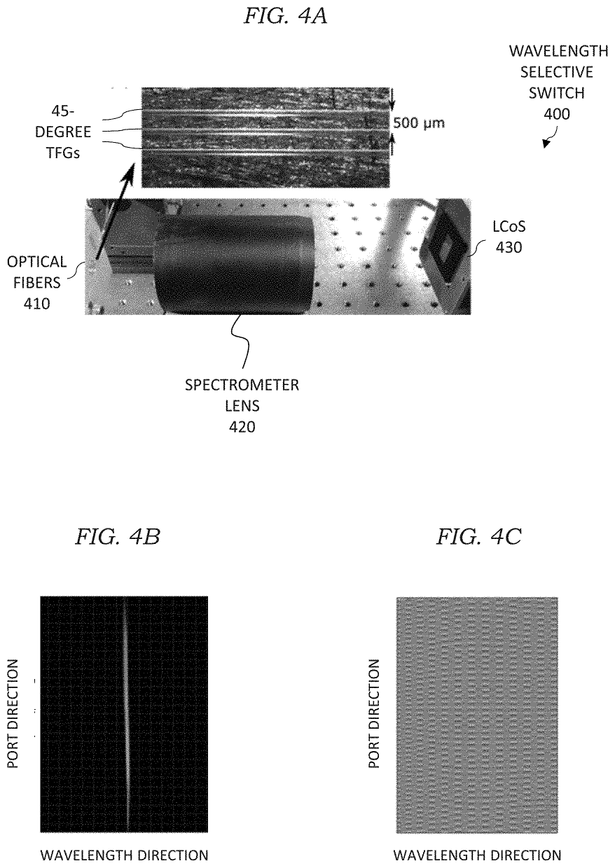

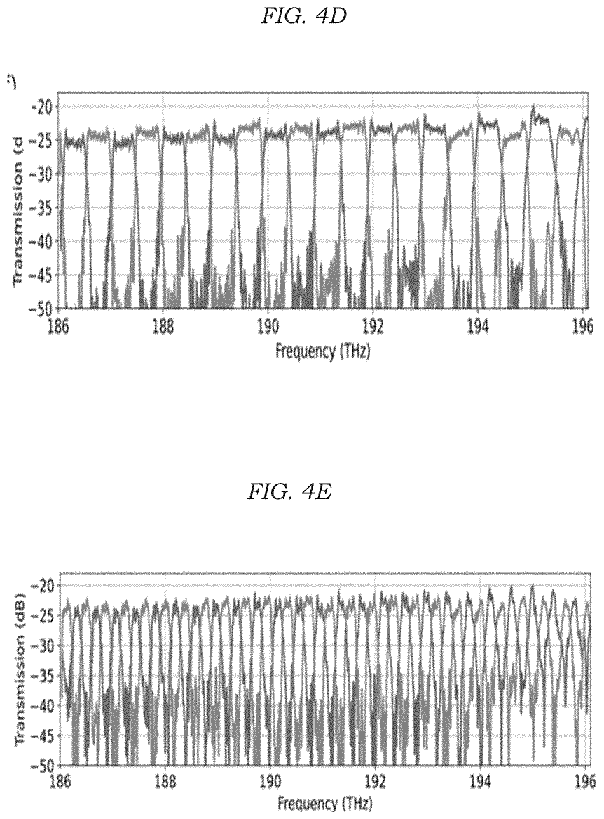

FIGS. 4A-4E depict aspects of an experiment for a wavelength selective switch using tilted fiber gratings for interleaving optical signals for two ports with 500 GHz spacing and 200 GHz spacing.

FIG. 4A depicts an experimental setup for a WSS 400 including direct grating interfaces. The WSS 400 includes an array of three optical fibers 410 having 45-degree TFGs, a cylindrical spectrometer lens 420, and an LCoS 430. The assembly of the 45-degree TFGs is depicted, illustrating 500 μm spacing between adjacent ones of the 45-degree TFGs. It will be appreciated that the WSS 400 depicted in FIG. 4 may be configured to provide the WSS 300 of FIG. 3 (e.g., with the three optical fibers 410 of the WSS 400 corresponding to the COM, Port 1, and Port 2 fibers of the WSS 300, respectively).

FIG. 4B depicts the light distribution at the plane of the LCoS 430. As depicted in FIG. 4B, which illustrates both the wavelength direction and the port direction, the light distribution is along the wavelength direction. It will be appreciated that changes in the wavelength of the light may cause the location of the light distribution to move left along the wavelength direction (e.g., for lower wavelength light) or right along the wavelength direction (e.g., for higher wavelength light).

FIG. 4C depicts the steering pattern on the LCoS 430. As depicted in FIG. 4C, which illustrates both the wavelength direction and the port direction, the steering pattern is configured to steer the light in the wavelength direction. This corresponds to the distribution of the light along the wavelength direction as depicted in FIG. 4B.

FIG. 4D depicts interleaving of optical signals for the two ports with 500 GHz spacing. It is noted that the frequency is specified in THz.

FIG. 4E depicts interleaving of optical signals for the two ports with 200 GHz spacing. It is noted that the frequency is specified in THz.

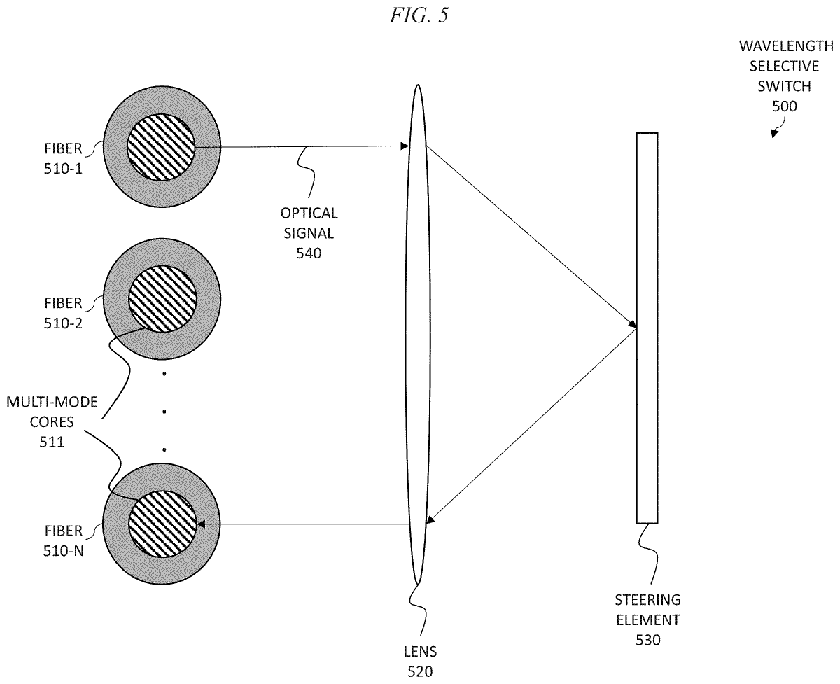

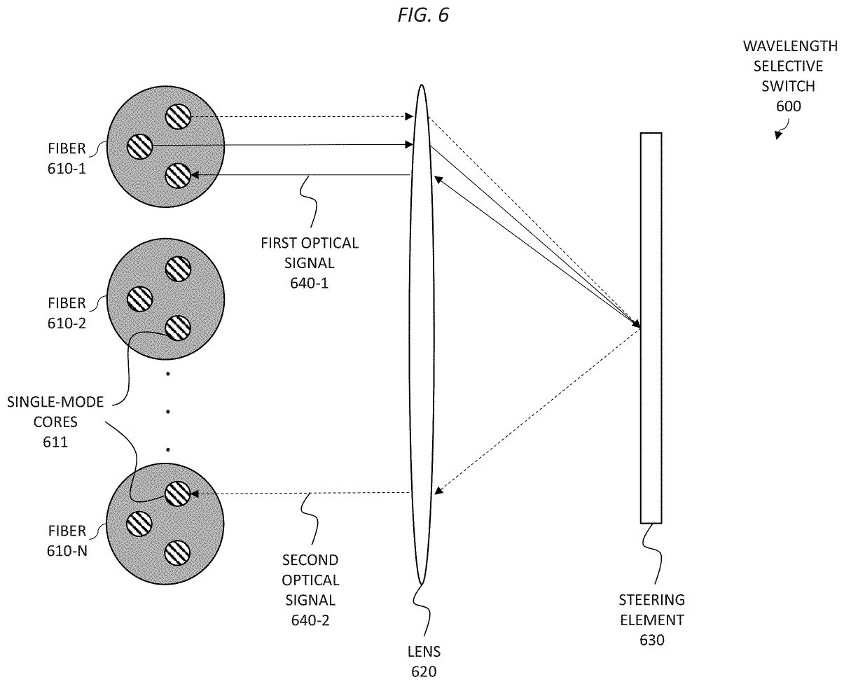

It will be appreciated that wavelength selective switches with direct grating interfaces may utilize various types of fibers, such as single-core multi-mode fibers (e.g., as presented in FIG. 5), multi-core single-mode fibers (e.g., as presented in FIG. 6), or the like, as well as various combinations thereof.

FIG. 5 depicts an example embodiment of a wavelength selective switch with direct grating interfaces integrated within single-core multi-mode fibers.

In FIG. 5, the WSS 500 includes a plurality of fibers 510-1-510-N (collectively, fibers 510), a lens 520, and a steering element 530. The fibers 510 are single-core multi-mode optical fibers. The fibers 510 have 45-degree TFGs inscribed therein (as indicated by the hatching pattern). The 45-degree TFGs, for light received on the fibers 510 that is to be switched, are configured to direct the light received on the fibers 510 toward the lens 520 for steering by the steering element 530. The 45-degree TFGs, for light steered by the steering element 530 that is to be further propagated on the fibers 510, are configured to direct light received from the lens 520 back onto the fibers 510 for further propagation on the fibers 510.

In the example of FIG. 5, an optical signal 540 is switched from the fiber 510-1 to the fiber 510-N. The optical signal 540 may be an individual wavelength channel, an optical beam composed of multiple wavelength channels, or the like. The 45-degree TFG of fiber 510-1 directs a portion of the light propagating along the fiber 510-1 to provide the optical signal 540 that is directed to the lens 520. The lens 520 directs the optical signal 540 that is received from the 45-degree TFG of fiber 510-1 to the steering element 530 for steering of the optical signal 540 toward the fiber 510-N. The steering element 530 steers the optical signal 540 received from the lens 520 back to the lens 520. The lens 520 focuses the optical signal 540 from the steering element 530 onto the 45-degree TFG of fiber 510-N. The 45-degree TFG of fiber 510-N directs the redirected optical signal 540 onto the fiber 510-N for further propagation along the fiber 510-N. In this manner, the optical signal 540 is switched from the fiber 510-1 to the fiber 510-N.

FIG. 6 depicts an example embodiment of a wavelength selective switch with direct grating interfaces integrated within multi-core single-mode fibers.

In FIG. 6, the WSS 600 includes a plurality of fibers 610-1-610-N (collectively, fibers 610), a lens 620, and a steering element 630. The fibers 610 are multi-core single-mode optical fibers, with each of the fibers 610 including three single-mode cores 611. The single-mode cores 611 of the fibers 610 have 45-degree TFGs inscribed therein (as indicated by the hatching pattern). The 45-degree TFGs, for light received on the fibers 610 that is to be switched, are configured to direct the light received on the fibers 610 toward the lens 620 for steering by the steering element 630. The 45-degree TFGs, for light steered by the steering element 630 that is to be further propagated on the fibers 610, are configured to direct light received from the lens 620 back onto the fibers 610 for further propagation on the fibers 610.

In the example of FIG. 6, a first optical signal 640-1 is switched between two single-mode cores 611 on the same fiber 610 (illustratively, between two of the single-mode cores 611 on the fiber 610-1). The 45-degree TFG of the ingress single-mode core 611 on the fiber 610-1 directs a portion of the light propagating along the ingress single-mode core 611 on the fiber 610-1 to provide the first optical signal 640-1 that is directed to the lens 620. The lens 620 directs the first optical signal 640-1 that is received from the 45-degree TFG of the ingress single-mode core 611 on the fiber 610-1 to the steering element 630 for steering of the first optical signal 640 toward an egress single-mode core 611 on the fiber 610-1. The steering element 630 steers the first optical signal 640-1 received from the lens 620 back to the lens 620. The lens 620 focuses the first optical signal 640-1 from the steering element 630 onto the 45-degree TFG of the egress single-mode core 611 on the fiber 610-1. The 45-degree TFG of the egress single-mode core 611 on the fiber 610-1 directs the redirected first optical signal 640-1 onto the egress single-mode core 611 on the fiber 610-1 for further propagation along the egress single-mode core 611 on the fiber 610-1. In this manner, the first optical signal 640-1 is switched between two of the single-mode cores 611 on the fiber 610-1.

In the example of FIG. 6, a second optical signal 640-2 is switched between two single-mode cores 611 on different fibers 610 (illustratively, from the fiber 610-1 to the fiber 610-N). The 45-degree TFG of the ingress single-mode core 611 on the fiber 610-1 directs a portion of the light propagating along the ingress single-mode core 611 on the fiber 610-1 to provide the second optical signal 640-2 that is directed to the lens 620. The lens 620 directs the second optical signal 640-2 that is received from the 45-degree TFG of the ingress single-mode core 611 on the fiber 610-1 to the steering element 630 for steering of the second optical signal 640-2 toward the egress single-mode core 611 on the fiber 610-N. The steering element 630 steers the second optical signal 640-2 received from the lens 620 back to the lens 620. The lens 620 focuses the second optical signal 640-2 from the steering element 630 onto the 45-degree TFG of the egress single-mode core 611 on the fiber 610-N. The 45-degree TFG of the egress single-mode core 611 on the fiber 610-N directs the redirected second optical signal 640-2 onto the egress single-mode core 611 on fiber 610-N for further propagation along the egress single-mode core 611 on the fiber 610-N. In this manner, the second optical signal 640-2 is switched from the fiber 610-1 to the fiber 610-N.

It will be appreciated that, although primarily presented with respect to example embodiments in which the fibers of a WSS include either single-core multi-mode fibers or multi-core single-mode fibers, combinations of such fibers may be used within a WSS.

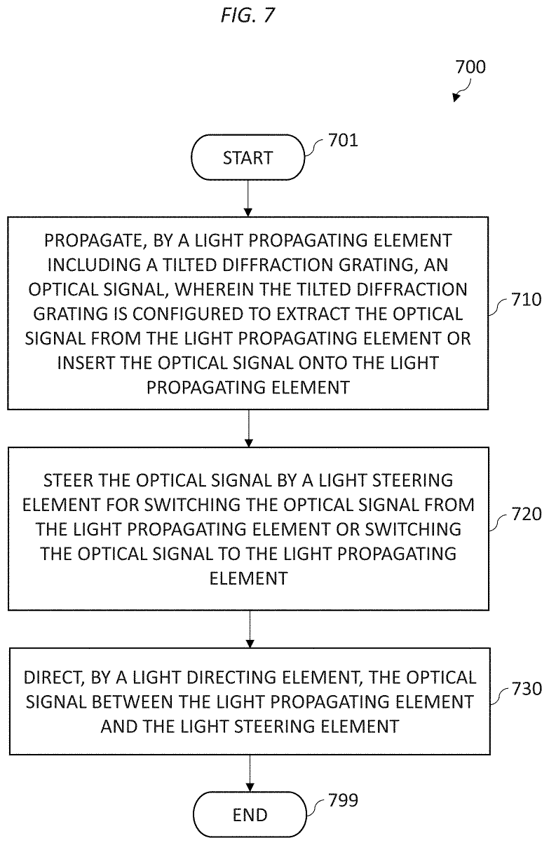

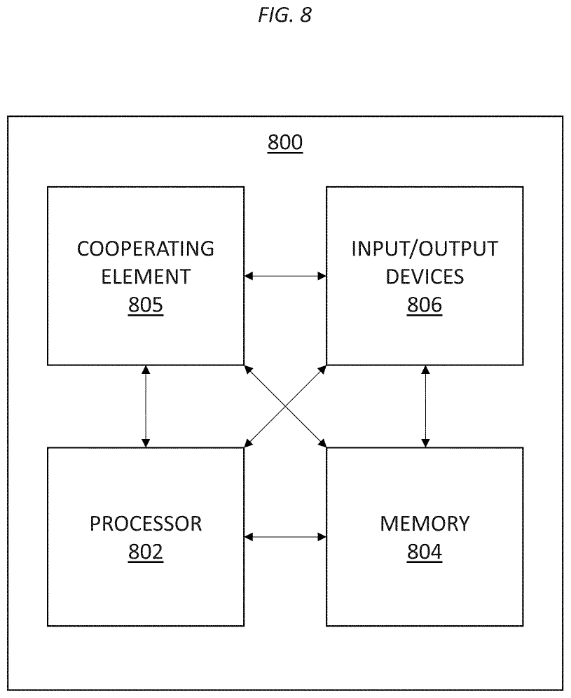

FIG. 7 depicts an example embodiment of a method for use of a wavelength selective switch including a direct grating interface. It will be appreciated that although primarily presented as being performed serially, at least a portion of the blocks of method 700 may be performed contemporaneously or in a different order than as presented in FIG. 7. At block 701, the method 700 begins. At block 710, propagate, by a light propagating element including a tilted diffraction grating, an optical signal, wherein the tilted diffraction grating is configured to extract the optical signal from the light propagating element or insert the optical signal onto the light propagating element. At block 720, steer the optical signal by a light steering element for switching the optical signal from the light propagating element or switching the optical signal to the light propagating element. At block 730, direct, by a light directing element, the optical signal between the light propagating element and the light steering element. At block 799, the method 700 ends.

Various example embodiments of a WSS including a direct grating interface may provide various advantages or potential advantages. For example, a WSS including a direct grating interface may reduce the size of the WSS, even enabling the WSS to be a compact WSS or even an ultra-compact WSS. Various example embodiments of a WSS including a direct grating interface may provide various other advantages or potential advantages.

FIG. 8 depicts an example embodiment of a computer suitable for use in performing various functions presented herein.

The computer 800 includes a processor 802 (e.g., a central processing unit (CPU), a processor, a processor having a set of processor cores, a processor core of a processor, or the like) and a memory 804 (e.g., a random access memory, a read only memory, or the like). The processor 802 and the memory 804 may be communicatively connected. In at least some example embodiments, the computer 800 may include at least one processor and at least one memory including a set of instructions, wherein the set of instructions is configured to, when executed by the at least one processor, cause the computer to perform various functions presented herein.

The computer 800 also may include a cooperating element 805. The cooperating element 805 may be a hardware device. The cooperating element 805 may be a process that can be loaded into the memory 804 and executed by the processor 802 to implement various functions presented herein (in which case, for example, the cooperating element 805 (including associated data structures) can be stored on a non-transitory computer-readable storage medium, such as a storage device or other suitable type of storage element (e.g., a magnetic drive, an optical drive, or the like)).

The computer 800 also may include one or more input/output devices 806. The input/output devices 806 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 800 may represent a general architecture and functionality suitable for implementing functional elements described herein, portions of functional elements described herein, or the like, as well as various combinations thereof. For example, computer 800 may provide a general architecture and functionality that is suitable for implementing one or more elements presented herein, such as a wavelength selective switch, an element of a wavelength selective switch, or the like, as well as various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1. An apparatus, comprising:
an optical fiber configured to propagate an optical signal, wherein the optical fiber includes a tilted fiber grating configured to extract the optical signal from the optical fiber or insert the optical signal onto the optical fiber for propagation thereon;
a light steering element configured to steer the optical signal for switching the optical signal from the optical fiber or switching the optical signal to the optical fiber; and
a light directing element configured to direct the optical signal between the optical fiber and the light steering element.

2. The apparatus of claim 1, wherein the optical signal is extracted from the optical fiber or inserted onto the optical fiber through a side portion of the optical fiber.

3. The apparatus of claim 1, wherein the tilted fiber grating is arranged to support propagation of the optical signal through a side portion of the optical fiber.

4. The apparatus of claim 1, wherein the tilted fiber grating has a tilt angle of between approximately 30 degrees and approximately 60 degrees.

5. The apparatus of claim 1, wherein the tilted fiber grating comprises an about 45-degree tilted fiber grating.

6. The apparatus of claim 1, wherein the tilted fiber grating is inscribed within the optical fiber.

7. The apparatus of claim 1, wherein the optical signal comprises an optical beam including one or more wavelength channels, wherein the tilted fiber grating is configured to direct different wavelength channels of the optical beam in different directions.

8. The apparatus of claim 1, wherein the optical signal comprises an optical beam including a plurality of wavelength channels, wherein the tilted fiber grating is configured to spectrally separate the optical beam into the plurality of wavelength channels.

9. The apparatus of claim 1, wherein the light directing element comprises at least one lens.

10. The apparatus of claim 9, wherein the at least one lens includes a first lens configured to direct the optical signal in a first direction and a second lens configured to direct the optical signal in a second direction.

11. The apparatus of claim 9, wherein the at least one lens comprises at least one spectrometer lens.

12. The apparatus of claim 1, wherein the light directing element is coupled to a portion of the optical fiber having the tilted fiber grating therein.

13. The apparatus of claim 1, wherein the light steering element includes at least one of an array of liquid crystal on silicon (LCoS) elements, an array of microelectromechanical (MEMS) elements, and a digital light processing (DLP) element.

14. The apparatus of claim 1, wherein the optical signal includes a wavelength channel, wherein the light steering element is configured to steer the wavelength channel between a segment of the optical fiber having the tilted fiber grating and a light propagating element.

15. The apparatus of claim 1, wherein the optical signal includes an optical beam comprising a set of N wavelength channels, wherein the light steering element is configured to steer the optical beam between a segment of the optical fiber having the tilted fiber grating and a light propagating element.

16. The apparatus of claim 1, wherein the optical signal includes an optical beam comprising a set of N wavelength channels, wherein the light steering element is configured to steer each of the N wavelength channels between the optical fiber and N light propagating elements.

17. The apparatus of claim 1, wherein the apparatus forms part of a wavelength selective switch.

18. The apparatus of claim 1, wherein the apparatus is a wavelength selective switch.

19. A wavelength selective switch, comprising:
an optical fiber configured to propagate an optical signal, wherein the optical fiber includes a tilted fiber grating configured to extract the optical signal from the optical fiber or insert the optical signal onto the optical fiber for propagation thereon;
a light steering element configured to steer the optical signal for switching the optical signal from the optical fiber or switching the optical signal to the optical fiber; and
a light directing element configured to direct the optical signal between the optical fiber and the light steering element.

20. A method, comprising:
propagating, by an optical fiber including a tilted fiber grating in a segment of the optical fiber, an optical signal, wherein the tilted fiber grating is configured to extract the optical signal from the optical fiber or insert the optical signal onto the optical fiber for propagation thereon;
steering the optical signal by a light steering element for switching the optical signal from the segment of the optical fiber or switching the optical signal to the segment of the optical fiber; and
directing, by a light directing element, the optical signal between the segment of the optical fiber and the light steering element.
